(19) United States
(12) Patent Application Publication
(10) Pub. No.: US 2005/0090208 A1
(43) Pub. Date: Apr. 28, 2005

(54) General radio frequency synthesizer (GRFS)

(75) Inventor: Rich Liao, Los Altos, CA (US)

Correspondence Address: Rich Liao, 759 Edge Lane, Los Altos, CA, 94024, US

(73) Assignee: Rich Liao, Los Altos, CA (US)

(21) Appl. No.: 10/643,416

(22) Filed: Aug. 19, 2003

(51) Int. Cl. H04B 1/04

(52) U.S. Cl. 455/112; 455/76

(57) ABSTRACT

The present invention provides cost-effective synthesizer and transceiver architecture having an instant channel switching for multiple wireless/wire network communication standards such as IEEE802.11 ab/g, Bluetooth, WCDMA, GSM QuadBand, CDMA dualband, GPS. This invention also enables multiple communication standards or multiple channels in one standard share the same fundamental frequency generators. This allows for a method of operating the transceiver and synthesizer, methods and apparatus of establishing or reestablishing a instant or simultaneously channel switching lock condition in a communication standard or among different communication standards.

### FIELD OF THE ART

The present invention relates to the field of signal processing and frequency synthesizer and communication transceiver architectures, more particularly, the present invention relates to a synthesizer, and in particular a synthesizer with PLL and a clock generator based on mixed-signal waveform generation for multi-channels, multi-mode, multiple wireless and wire communications standards in a class of very compact and cost-effective architectures.

### BACKGROUND DESCRIPTION OF THE RELATED ART

A communication system transfers information between a source and a destination. Generally, a communication system includes at least one transmitter and one receiver which transmit and receive information signals over some media, respectively. This media may be cable wiring or no wiring, like atmosphere. When communications occur over no wiring, they are commonly referred to as “wireless” communications. Examples of wireless communications systems include wireless modems, digital cellular, digital cordless telephones, wireless local and wide area networks, digital satellite communications and personal communications networks. This invention is related to frequency planning, frequency synthesizer and transceiver architectures for communication standards like IEEE802.11a/b/g WLAN, Bluetooth, WCDMA, GSM quad-band, and CDMA dual-band etc. . . .

Communication transmitters are usually in direct conversion. The receivers have a number of different architectures, including multi-stage and direct conversion. These approaches have a number of different problems associated with them. For example, in multi-stage approaches, the low intermediate frequency (IF) required for use with certain filters results in an image channel that is fairly dose to the desired RF signal. To compensate for this close image channel, the receiver requires a sharp image-rejection filter in the front-end in order to provide enough image suppression prior to mixing. Direct conversion architectures can be designed so that the image signal and the desired channel are essentially the same so that there is no need for an image rejection filter. However, imperfect isolation between the local oscillator (LO) and the antenna results in the LO signal being detected by the antenna, thereby producing a DC component at the output of the receivers. Also, most of the signal amplification is usually performed at the base-band and consequently the signal level at the input of channel-selection filters may be low enough to be completely masked by the 1/f noise. The frequency plan and synthesizer design provide the possibility to adapt all the possible architecture mentioned above, either in transmitter and receiver sides for different circuit device process technology.

In many modern wireless communication standards, the bandwidth is partitioned into many channels with certain carrier frequencies. Synthesizers are used in communication devices to obtain an output signal that is synchronized with some other signal, such as reference signal to generate signals with those frequencies. Certain synthesizers use what is known as phase locked loop (PLL) with programmable dividers and a voltage controlled oscillator (VCO) to cause the output signal frequency to vary in dependence upon the input control voltage. In this traditional approach, the frequency synthesizer, VCO tuning range, frequency divider locking range needs to be extended as bandwidth and channel number increase. And the channel switching capability need more complicated design to meet the lock control, stability, phase noise, channel switching lock-in time and power consumptions etc . . . requirements.

### BRIEF SUMMARY OF THE INVENTION

The invention provides the frequency plan, frequency synthesizer and transceiver architectures to be easier for fine tuning to meet the system requirements. As more communication standards are integrated into a single mobile device, the invention provides a single transceiver device to have multi-mode or multiple standard frequency channels access capability with one single frequency synthesizer. Furthermore, the invention provides a compact and cost-effective frequency synthesizer architecture for multi-port communication systems like WLAN IEEE802.11ab/g access points, 3G wireless base-station or one with any and any combination of standards in Table.1 or claim 2.

### SUMMARY OF THE INVENTION

It is an object of the present invention to provide frequency plan and architectures for the frequency synthesizer and transceiver to meet multiple wireless communication standards at one frequency planning design, especially with instant and simultaneously channel switching capability, which is difficult for the traditional frequency synthesizer with programmable divider mentioned in above prior art. The invention also provides a cost-effective for multi-port WLAN or 3G wireless base stations. The invention will also provide the new and cost-effective wireless device to enable next generation wireless network with fast and simultaneously channel switching capability to improve the communication efficiency and make the other wireless RF circuits blocks easier for implementations.

It is another object of the present invention to provide a method of and apparatus for generating different frequency signals for synthesizing the desired frequency signal with robust and simple circuit implementations.

It is another object of the present invention to provide a method to systematically obtain a pure spectrum carrier frequency signals based on main constant frequency source to meet multiple communication standards requirement and easily fine tune the phase noise performance to meet the requirement of various wireless communication system.

The present invention attains at least the above objects, and others, either singly or in combination, by providing a synthesizer having an instant/simultaneously channel switching lock condition without the traditional programmable divider. This allows for a method of operating the synthesizer, methods of establishing or reestablishing a lock condition using a frequency source like a fine tuned single frequency VCO without complicated design to extend the frequency tuning range of the VCO. It also enables the utilization of a high radio frequency source such as micromachining oscillators with less phase noise to meet the advanced wireless communication system requirement.

Advantages of each of the above-recited aspects of the present invention will become apparent in the discussion provided hereinafter.

### DESCRIPTION

### BRIEF DESCRIPTION OF THE DRAWINGS

The above and other objectives, features, and advantages of the present invention are further described in the detailed description which follows, with reference to the drawings by way of non-limiting exemplary embodiments of the present invention, wherein like reference numerals represent similar parts of the present invention throughout several views and wherein:

FIG. 1 is a block diagram of one embodiment of frequency synthesizer of the front-end circuitry for use in a communications device.

FIG. 2 This exemplary design is dedicated to direct conversion transceiver.

FIG. 3 This exemplary design is dedicated to a direct conversion transmitter and a multi-stage down-conversion receiver.

FIG. 4 illustrates a conventional PLL circuit that uses a VCO to generate the two main classes of constant frequencies f1 and f2.

FIG. 5 quadrature superharmonic frequency dividers

FIG. 6 Architecture of the mixed-signal waveform clock generator

FIG. 7 illustrate the frequency mixer architectures according to the present invention;

FIG. 8 This exemplary design is a direct conversion transceiver dedicated to the GRFS to support multi-mode IEEE802.11a/b/g WLAN transceiver and Bluetooth

FIG. 9 This exemplary design is a direct conversion transmitter and High-IF multi-stage receiver dedicated to the GRFS to support multi-mode IEEE802.11a/b/g WLAN transceiver and Bluetooth

FIG. 10 This exemplary design is a direct conversion transmitter and Low-IF multi-stage receiver dedicated to the GRFS to support multi-mode IEEE802.11a/b/g WLAN transceiver and Bluetooth

FIG. 11 This exemplary design is dedicated to a multi-port trnsceiver sharing the same f1 and f2 frequency generators.

### DETAILED DESCRIPTION OF THE INVENTION

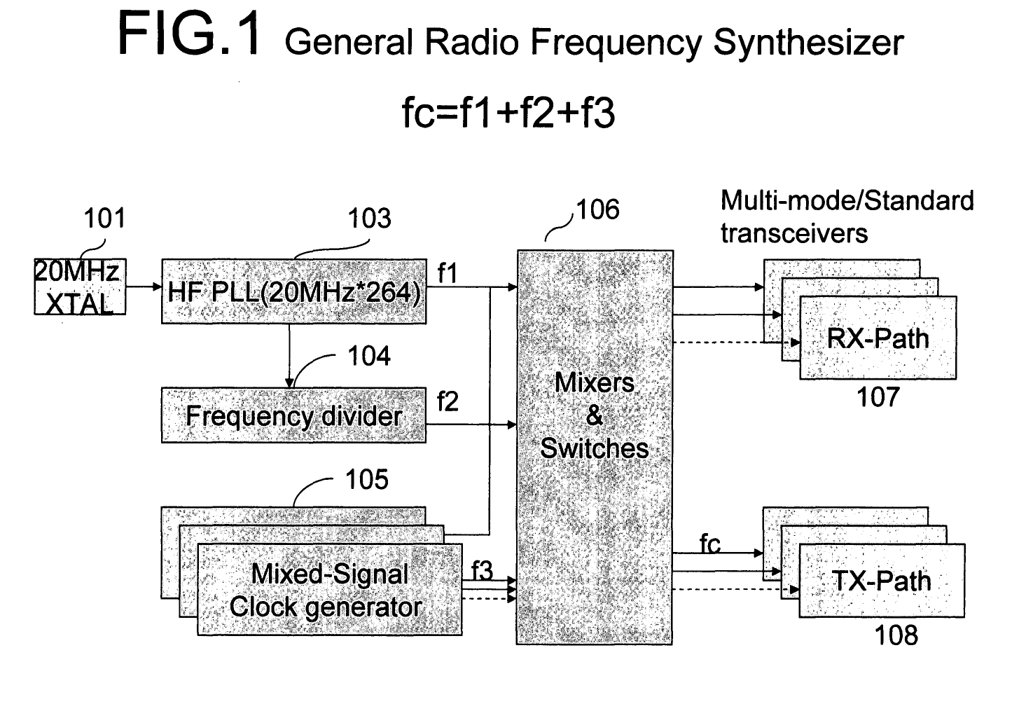

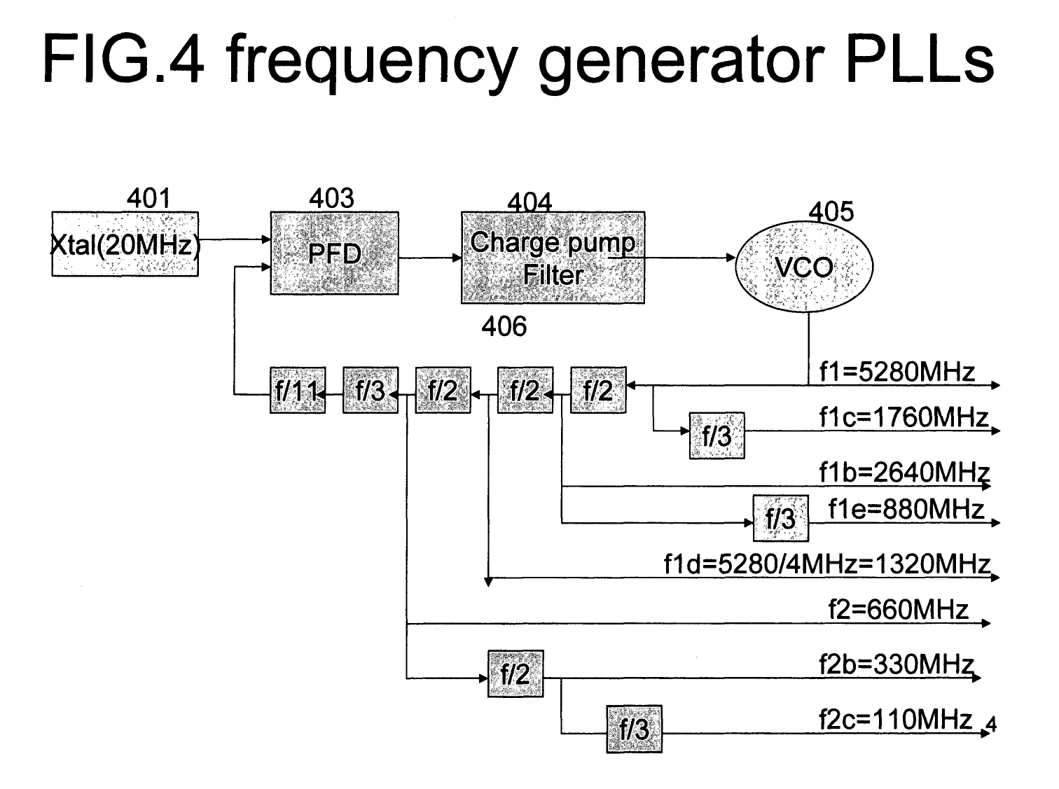

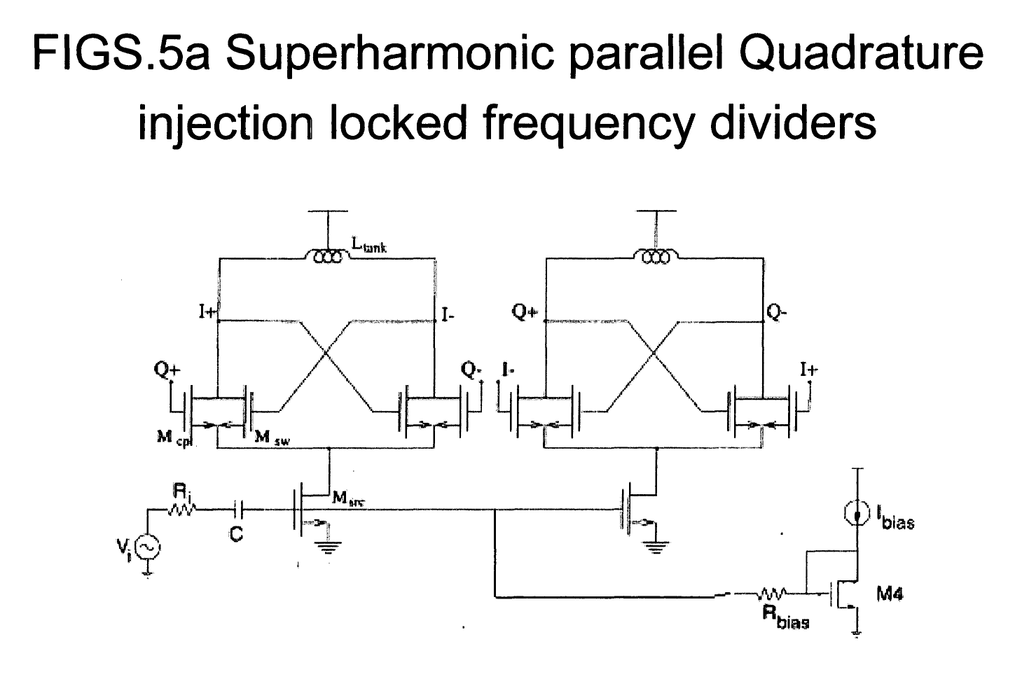

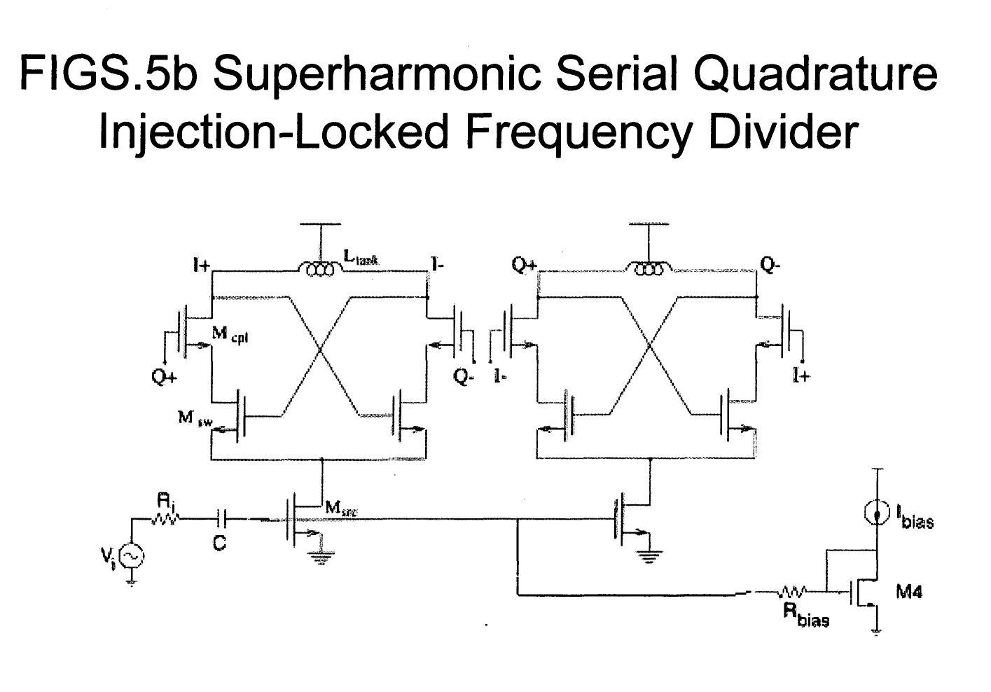

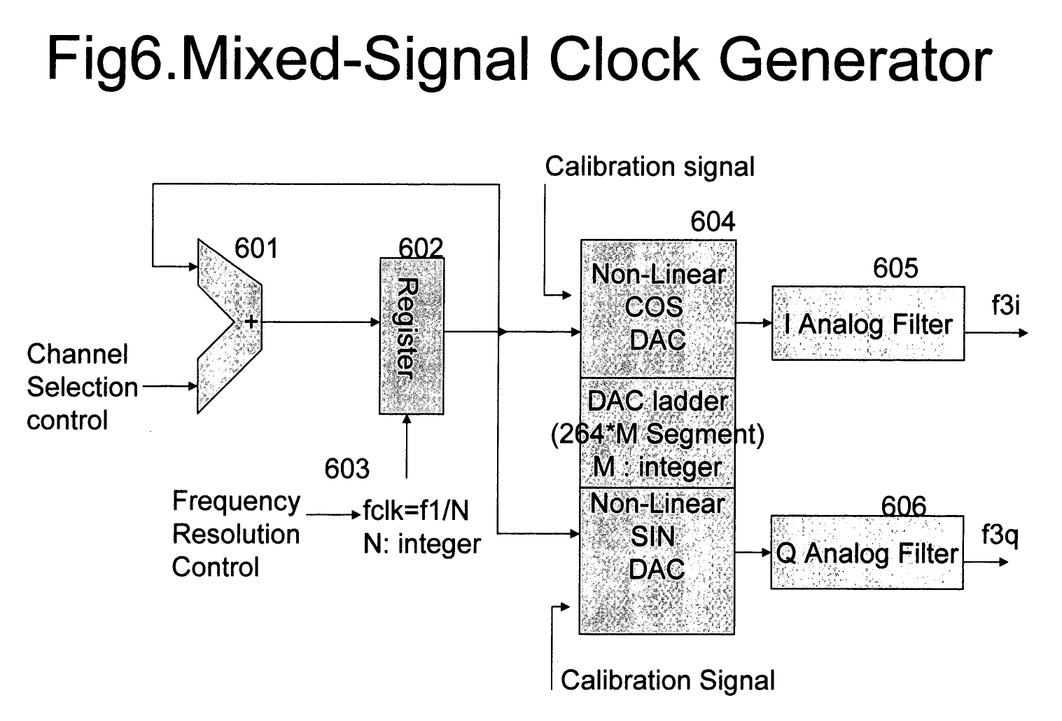

The present invention shown in FIG. 1 provides a synthesizer for use in multi-mode, multi-standard and multi-port communication devices, which, unlike conventional synthesizers, uses a PLL with a VCO to cause an output signal frequency to vary in dependence upon an input control voltage and programmable frequency dividers. The frequency synthesizer is composed of one single constant high radio frequency generator based on PLL and dividers as shown in FIG. 5 to generate two classes of frequencies f1 and f2 in FIG. 4 and a mixed-signal f3 frequency generator in FIG. 6 to provide instant and simultaneously channel switching lock capability. Those aspects of the present invention that differ from a conventional synthesizer will accordingly be described hereinafter, with the conventional PLL single frequency generator portions not being described in detail. Furthermore, the high frequency generator for f1 and f2 is not necessarily generated by traditional VCO circuits, it can use oscillators with frequency dividers made by Micromachining device and other stable frequency reference to met the communication system requirement such as phase noise and power consumptions. And the mixed-signal f3 waveform synthesizer can also be a direct digital frequency synthesizer (DDFS) circuits which need more complicated design and power consumption.

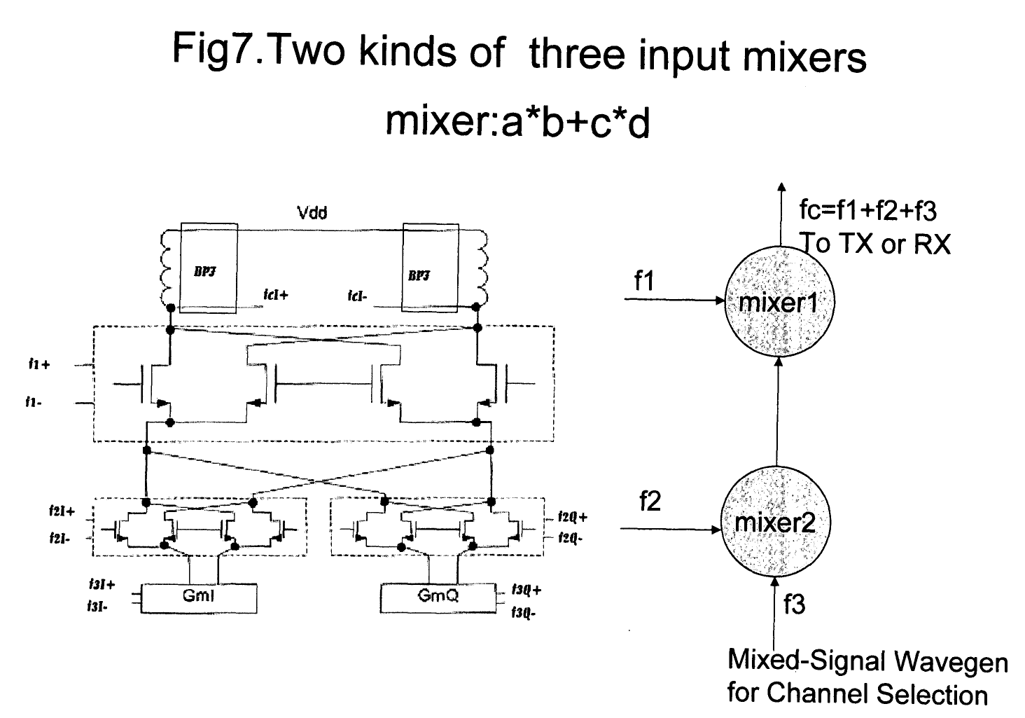

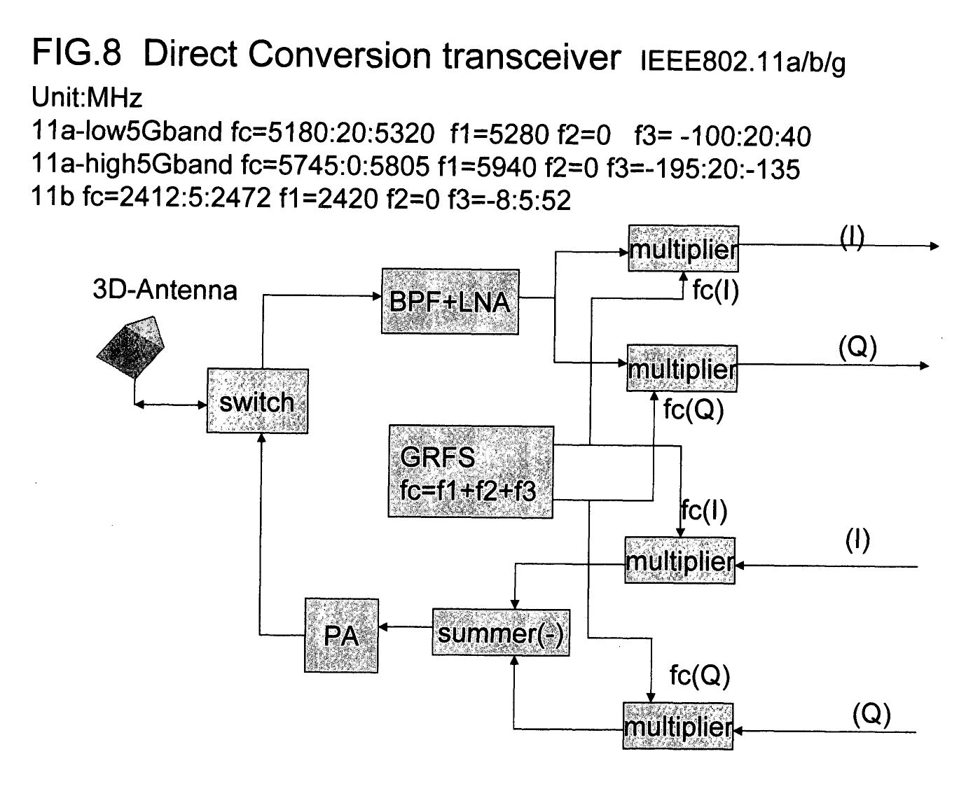

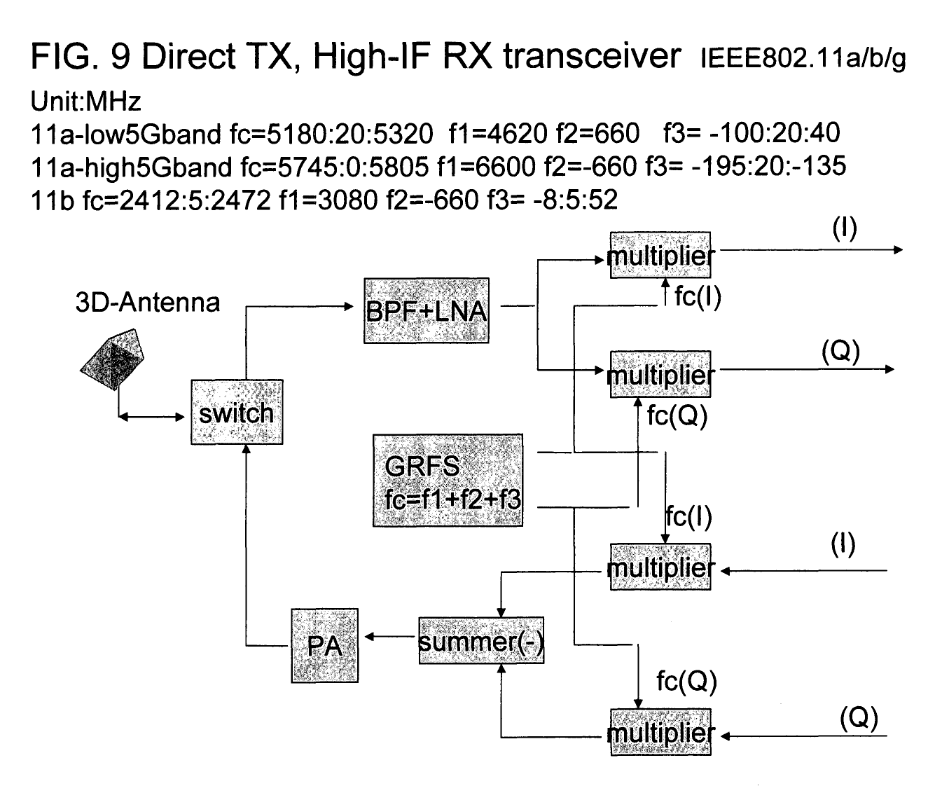

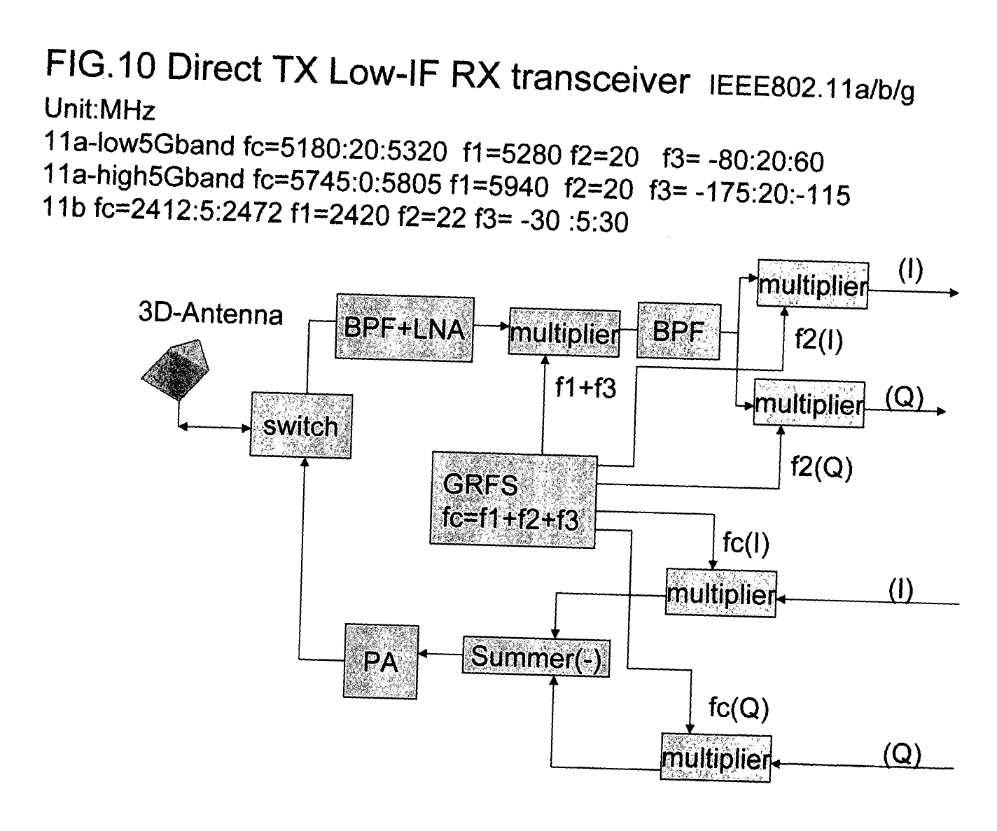

As mentioned above, it is desirable to generate fist channel switching lock within one communication standard or among different communication standard and meet the phase noise requirement. This invention can simplify the design complexity and meet the spec. requirement easily by the well frequency planning invention. In Table .1 we show the frequency planning for multiple wireless communication standards based on this invention. A 20 MHz reference crystal oscillator is used as a reference to generate the desired 5280 MHz from the first PLL frequency generator with a constant divided-by-264 divider consisted of three divide-by-two circuits, one divided-by-three, and one divided-by-eleven circuit as shown in FIG. 4. And the 2640 MHz signal is generated by a quadrature injection locking divided-by-two circuit with the 5280 MHz signal as input. With the constant frequency divider operations, the 5280 MHz/M, M=1,2,3,4,6,8,16,48, frequencies are generated to be synthesized with f3 for multi-mode and multi-standard wireless communication systems. As shown in Table 1. The f3 frequency ranges of the mixed signal waveform generator are optimized for all the wireless communications system on the list. It is a dedicated design of the non-linear mathematic COS and SIN waveform generator for f3 frequency generation without any big memory device which consumes a lot of area and power inside the tradition direct digital frequency generator. And the DAC cell is fine tuned to the non-linear value according to the sinusoidal waveform The positive and negative frequency of f3 is depended on the positive and negative summation operation of the channel selection control bits in FIG. 6. The frequency summation operations are based on dual inputs balanced mixer or triple inputs balanced mixer as shown in FIG. 7 shown in CMOS topologies. With the above preferred circuit embodiment implementation, they can be applied in direct conversion, low-IF and high-IF transceivers as sown in FIG. 8 FIG. 9 and FIG. 10.

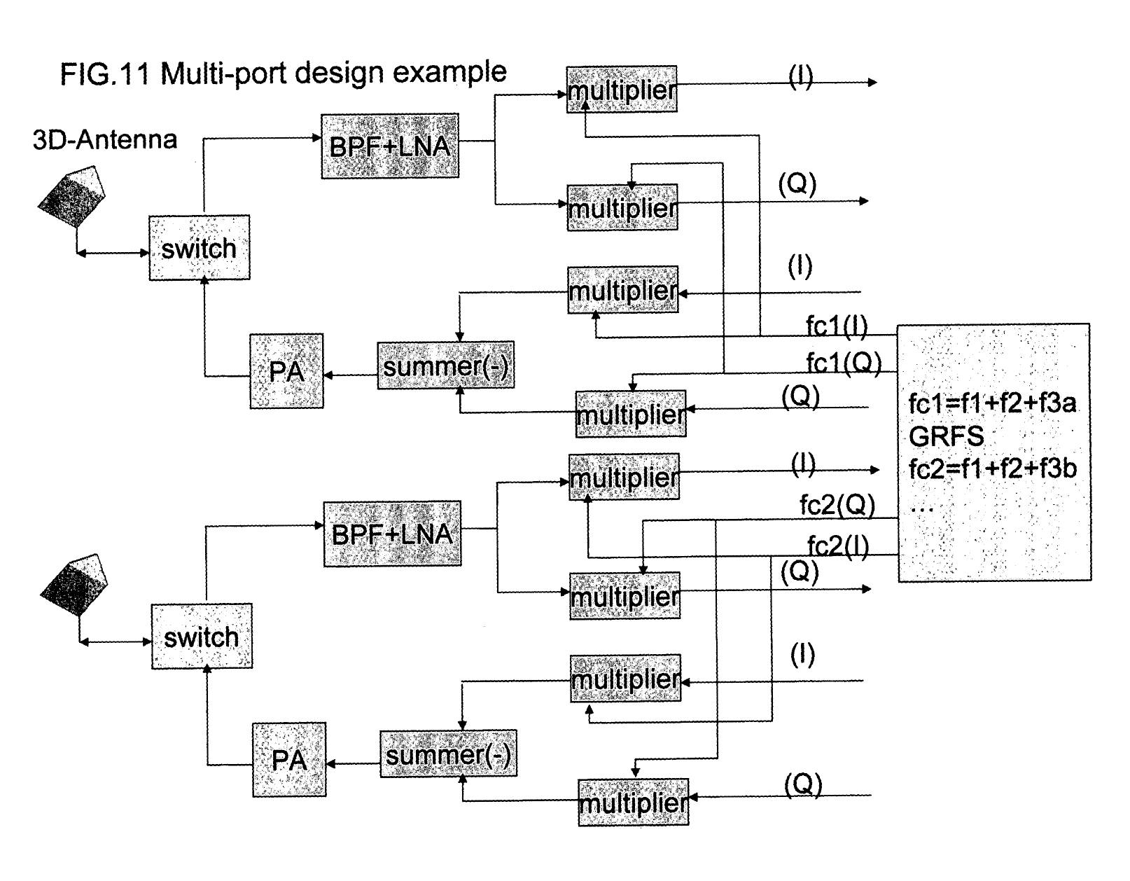

The invention can be used as a single carrier fc frequency synthesizer for not only a single standard multi-mode device but also multi-mode and multi-standard device as shown in FIG. 1 according to the frequency plan in Table.1 such as a combo IEEE802.11a/b/g, Bluetooth, WCDMA, CDMA dual-band, GSM quad-band, and GPS transceivers. The channel switching time is almost zero in this frequency synthesizer architecture. It can also be used as multiple ports frequency synthesizers in not only a single standard multi-mode communication system but also multi-mode and multi-standard system by adding more f3 frequency generators without adding more f1 and f2 frequency generators as shown in FIG. 11. The f1=5280 MHz frequency generator can also be used with constant frequency generators for generating the 11 MHz, 22 MHz, 44 Mz, 88 MHz clocks for the IEEE802.11b/g and cable modem applications. That is, this frequency planning and frequency synthesizer architecture is also fit for a broadband gateway or routers with wireless links. By this invention, the frequency synthesizer design can be very compact and cost-effective in various communications networking systems.

Although the present invention has been described in detail with reference to the preferred embodiments thereof, those skilled in the art will appreciate that various substitutions and modifications can be made to the examples described herein while remaining within the spirit and scope of the invention as defined in the appended claims.

TABLE 1
Frequency Plan of frequency synthesizer and transceiver for wireless
communication networking systems.

| | f1: | | |
|---|---|---|---|
| | Direct Conversion | | |
| Unit:MHz | Multi-stage | f2 | f3 |
| IEEE802.11a | 5280 | 0 | −100:20:40 |
| Lower 5G Band | 4620 = 5280 − 660 | 660 | |
| 5180:20:5320 | | | |
| IEEE802.11a | 5940 = 5280 + 660 | 0 | −195:20:−135 |
| Upper 5G Band | 6600 = 5940 + 660 | −660 | |
| 5745:20:5805 | | | |
| IEEE802.11b/g | 2420 = 5280/3 + 660 | 0 | −8:5:52 |
| 2412:5:2472 | 3080 = 2420 + 660 | −660 | |
| Bluetooth | 2420 | 0 | −18:1:60 |
| 2402:2480 | 3080 | −660 | |
| WCDMA | 1980 = 5280/4 + 660 | 0 | −60:5:0 |
| BS:1920:5:1980 | 1320 = 5280/4 | 660 | |
| MS:2110:5:2170 | 2090 = 5280/3 + 660/2 | 0 | 20:5:80 |
| | 1430 = 5280/3 − 660/2 | 660 | |
| GSM Quadband | 880 = 5280/6 | 0 | −11:0.2:14 |
| 869:894 | 1540 = 880 + 660 | −660 | |
| 925:960 | 880 | 0 | 45:80 |
| | 1540 | −660 | |
| 1805:1880 | 1870 = 5280/3 + 660/6 | 0 | −65:10 |
| | 1210 = 1870 − 660 | 660 | |
| 1930:1990 | 1980 = 5280/4 + 660 | 0 | −50:10 |
| | 1320 | 660 | |
| 824:849 | 880 | 0 | −56:−31 |
| | 1540 | −660 | |
| 880:915 | 880 | 0 | 0:35 |
| | 1540 | −660 | |
| 1710:1785 | 1760 = 5280/3 | 0 | −50:25 |
| | 1100 = 1760 − 660 | 660 | |
| 1850:1910 | 1870 = 5280/3 + 660/6 | 0 | −20:40 |
| | 1210 = 1885 − 660 | 660 | |
| CDMA Dualband | 880 | 0 | −56:45 |
| celluar 824:925 | 1540 | −660 | |
| PCS:1750:1980 | 1870 | 0 | −120:110 |
| | 1210 | 660 | |

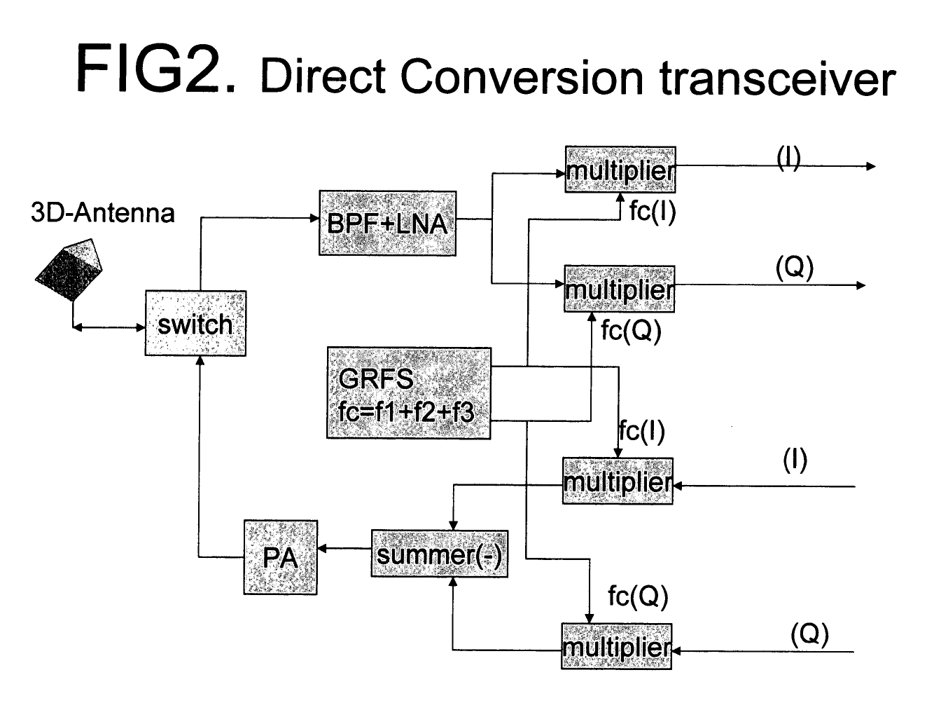

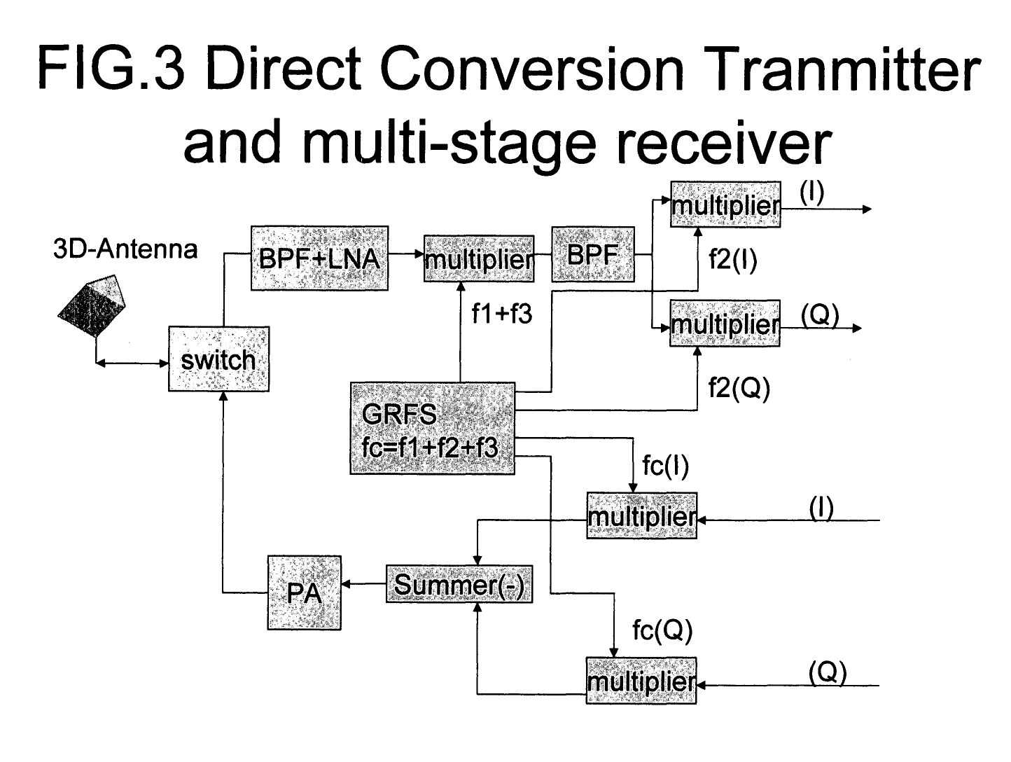

1. Apparatus for transmitting and receiving signals that is in conformity with a communications standard or among multi-standard and comprises a carrier signal modulated by a wanted signal, said communications standard defining a plurality of communications channels having central frequencies that are separated from one another by a fixed frequency referred to as a channel spacing, the modulated carrier signal occupying one of said plurality of communications channels, the apparatus including the first high frequency(HF) PLL 103 to generate f1 and f2 at an actual local oscillator frequencies which differs from said central frequency of the channel occupied by said wanted signal by a frequency difference f3 whose frequency is generated by a programmable mixed-signal waveform generator 104 followed with Digital to Analog Converters (DAC) and a filters. The mixing operation can be up conversion or down conversion.
For up conversion f_up=fa+fb it is generated by cos(2*pi*f_up*t)=cos(2*pi*fa*t)* cos(2*pi*fb*t)−sin(2*pi*fa*t)*sin(2*pi*fb*t). and sin(2*pi*f-up*t)=sin(2*pi*fa*t)*con(2*pi*fb*t)+cos(2*pi*fa*t)*sin(2*pi*fb*t).
For down conversion f_down=fa−fb,it is generated by cos(2*pi*f_down*t)=cos(2*pi*fa*t)*cos(2*pi*fb*t)+sin(2*pi*fa*t)*sin(2*pi*fb*t) and sin(2*pi*f_down*t)=sin(2*pi*fa*t)*cos(2*pi*fb*t)−cos(2*pi*fa*t)*sin(2*pi*fb*t).
The transmitter 107 mixes the transmitted data signal and the final carrier frequency signal produced by mixing f1,f2 and f3 frequency signals, that is fc=((f1+f2)+f3), from the GRFS in FIG. 1. The receiver 108 can be in direct conversion receiving or multi-stage down conversion by the frequency plan defined in this invention as shown in FIG. 2 and FIG. 3. or claim 2. And multiple transceivers in different carrier channels can share the same f1 and f2 frequency generators in a communication system like multi-port WLAN switch or hub access points as also shown in FIG. 1.

2. A method according to claim 1 wherein the operation as shown in Table.1
For example, a direct conversion operation as shown in FIG. 2, IEEE802.1 a WLAN f1=5280 MHz, f2=0 and f3=−100 MHz to 40 MHz with 20 MHz step for lower 5 GHz band (5180 MHz:20 MHz:5320 MHz) and f1=5940 MHz, f2=0 and f3=−195 MHz to −135 MHz with 20 MHz step for upper 5 GHz band (5745 MHz:20 MHz:5805 MHz).
For IEEE802.11b/g WLAN (2412 MHz:5 MHz:2472 MHz), f1=2420 MHz, f2=0, f3=−8 MHz to 52 MHz with 5 MHz step for IEEE802.11b and 20 MHz for IEEE802.11g, the 11 MHz baseband digital clock is also generated by 5280 MHz/480. For IEEE802.11b multistage low-IF receiver, f1+f2+f3=fc−22 MHz as shown in FIG. 10, the 22 MHz difference is processing by digital mixer operation with a 88 MHz clock from 5280 MHz/60. The same low-IF approach can also applied to other wireless communication standard in the innovative frequency planning and synthesizer design. Since, the transceiver and base-band is WLAN oriented, the circuit blocks in transmitter and receiver paths such as data converters and DSP processing power in base-band are good enough to handle all the communication standard listed in table1. That is this frequency planning and architecture of the general radio frequency synthesizer can be applied in direct conversion and low-IF and high-IF transceiver architectures. Therefore, this invention can be a general radio frequency synthesizer for current and future wireless communication standard.
For Bluetooth (2402 MHz:1 MHz:2480 MHz), f1=2420 MHz, f2=0 MHz and f3=18 Hz to 60 MHz with 1 MHz step.
For WCDMA (1920 MHz:5 MHz:1980 MHz), f1=1980 MHz, f2=0 MHz and f3=−60 MHz: 5 MHz:0 MHz
For WCDMA (2110 MHz:5 MHz:2170 MHz), f1=2090 MHz, f2=0 MHz and f3=20 MHz: 5 MHz: 80 MHz
For multi-stage operation with a central 660 MHz Band Pass Filter (BPF) as shown in FIG. 3 or in Table 1, the positive and negative sign operation of f2, can also be decoded by the base-band signal processing. The f3 frequency range is for current carious wireless communication standard, it can be extended to several hundred mega hertz and the resolution can be changed by the apparatus shown in FIG. 6 to meet next generation wireless standard requirement.

3. A method and apparatus of single frequency generators according to claim 1 is shown in FIG. 4. For 5280 MHz, it is generated from a 20 MHz crystal 401 reference signal with quadrature VCO 405 circuits to produce HF f1 signals I,Q. For minimizing phase noise for some communication standards like IEEE802.11a/g OFDM system, the frequency tuning of the PLLs' charge pump 404 are disabled during transmitting or receiving data packets. Innovative Superharmonic Quadrature Injection-Locked Frequency Dividers as shown in FIG. 5 are invented to produce a single constant frequency analog division operation with IQ quadrature outputs. The divider can also be implemented by a frequency divider with poly-phase filters to generate the IQ quadrature phase outputs.

4. A method and apparatus of mixed-signal frequency generator is shown in FIG. 6. The channel spacing is controlled by the frequency resolution control bits to choose the DAC sampling frequency and the channel spacing input bits for the input of modulo-counter/adder 601. The sampling clock can be from the output after the constant divider of f1 or f2 PLL for different communication standards. The non-linear DAC is sinusoidal waveform shaped. They share the same DAC ladder block 604 with I,Q sample and hold circuits followed by low pass analog filters 605, 606.

5. A method and apparatus of mixer in claim 1 is Shown in FIG. 7. A two-port double balanced mixer of up-conversion or down-conversion is defined in claim 1. The mixer can also be implemented by a multiplier with image rejection filters or band-pass filters. Three input port mixer operations can be a cascade of two two input port mixer or integrated in one circuit as triple balanced mixer shown in FIG. 6.

6. A method and apparatus for instant/simultaneously channel switching is then be achieved according to claim 1-5.

7. A method and apparatus for minimize the phase noise of oscillator is also provided in by fine tuning a single frequency oscillator instead of tuning over the extension range of VCOs in traditional frequency synthesizer with programmable counters frequency dividers. Since the two main f1 f2 are constant frequencies, the low power dividerless PLL frequency generator with aperture phase detector can also be applied in this frequency synthesizer architecture.

8. A method and apparatus for accessing multi-mode wireless communication is achieved by switching the f1, f2, and f3. For example, from IEEE802.11a to IEEE802.11b, f1 is switching from 5280 MHz to 5280 MHz/3+660 MHz. And the channel frequency is selected by changing f3. By the same method and apparatus, this invention enables the channel carrier frequency fast switching from one standard to another one, by select the f1, f2, and f3 according to table.1. And f1 and f2 are the outputs of the constant dividers of fine tuned single frequency source. More than one communication standard can also be simultaneously achieved by adding more mixed-signal waveform generator and mixers to provide another carrier frequency without adding more the main RF PLL frequency generators to reproduce f1 and f2.

9. A single frequency synthesizer design method and apparatus is then provided to enable a base-station or mobile station to meet multi-port wireless communication networking operation by adding more mixed-signal frequency generator f3s without adding more f1 and f2 PLL frequency generators to save BOM cost and power consumptions. With the same method, the invention also enables the apparatus to provide carrier frequencies in multi-mode or multiple standards simultaneously in the cost effective frequency synthesis solutions. And the 11 MHz*N=1,2,4,8, . . . for IEEE802.11 b/g and cable modem bae-band clock can be generated from the 5280 MHz VCO by the constant frequency dividers. Therefore, this invention is also suitable to be applied in a broadband gateway or router systems with wireless links.

10. Method and apparatus apply not only the standard in claim 2 or table 1. but also for current others communication standard and the future next generation communication standards.

11. The mixed-signal waveform generator in claim 4 can also be a summing of multiple frequency generators to enable the broadcast function in wireless communication network The compact version of multiple frequencies generator is a FFT professor. The f3 mixed-signal waveform generator can also be replaced by a traditional direct digital frequency synthesizer. The frequency range of f3 is not limited by table1. The range can be extended by modifying the design in FIG. 6.

12. The claim of the frequency synthesizer for multimode and multi-standard wireless communication can be any combinations of the communication standards in claims 2/Table 1 and claim 10.
